(19) United States
(12) Patent Application Publication
(10) Pub. No.: US 2023/0270035 A1
(43) Pub. Date: Aug. 31, 2023

(54) Winged and Angularly Adjustable Scraper Assembly for Disc-Based Furrow Openers of a Seeding Implement

(71) Applicant: Atom Jet Industries (2002) Ltd., Brandon (CA)

(72) Inventors: Noel Lagarde, Brandon (CA); Rylan Groening, Brandon (CA); Wylie Somersall, Brandon (CA)

(21) Appl. No.: 18/151,022

(22) Filed: Jan. 6, 2023

Related U.S. Application Data
(60) Provisional application No. 63/314,804, filed on Feb. 28, 2022.

(51) Int. Cl. A01B 15/16; A01C 5/06

(52) U.S. Cl. CPC A01B 15/16; A01C 5/064

(57) ABSTRACT

A row unit for a seeding implement features a coulter disc, an angularly variable link on which the disc is carried, a scraper body supported on the link, and a wing projecting laterally from an outer side of the scraper body. The scraper body is supported in an adjustable manner selectively repositionable into a plurality of differently pitched orientations, relative to the link, about a reference axis that transversely penetrates the disc plane. By adjusting the pitch angle of the scraper body in a local reference frame of the link, one can better achieve a proper effective working orientation of the wing for each of a plurality of differently angulated link positions, each of which corresponds to a different working depth of the row unit. Though this novel adjustability, winged scrapers previously limited to use on parallel link row units can now be effectively used on other row units.

### CROSS-REFERENCE TO RELATED APPLICATIONS

This application claims benefit under 35 U.S.C. 119(e) of U.S. Provisional Application No. 63/314,804, filed Feb. 28, 2022, the entirety of which is incorporated herein by reference.

### FIELD OF THE INVENTION

The present invention relates generally to disc-based furrow openers for agricultural seeding implements, and more particularly to improved disc-scraper arrangements for same.

### BACKGROUND

Applicant's prior U.S. Pat. Nos. 7,568,438 and 10,368,472, the entireties of which are incorporated herein by reference, disclose disc furrow openers in which a scraper is carried alongside the disc to clear soil buildup therefrom, while also forming a shelf in the side of the disc-cut furrow trench to enable separate placement of seed and fertilizer at the shelf and the trench bottom. A leading front edge of the scraper resides in close proximity to the disc to perform the scraping action, and the scraper angles obliquely outward from this edge to form a space between the disc and the scraper into which seed and fertilizer are safely delivered to the shelved furrow behind the cover of the scraper. Select embodiments includes a carbide wing projecting laterally from the scraper at the outer side thereof opposite the disc in order to cut a widened shelf area alongside the primary furrow trench.

Applicant's already commercialized implementations of that winged scraper were particularly designed for compatibility with seeding implements that feature parallel-linkage row units. Owing to mounting of the winged scraper to a consistently orientated part of the parallel linkage, the orientation of the winged scraper is unaffected by adjustment of the row unit's working depth. Accordingly, the wing of the scraper remains properly positioned for its intended purpose regardless of the set working depth of the row unit.

However, there are other seeding implements that do not employ parallel linkages in the design of their row units, and on which Applicant's existing winged scraper design is therefore not optimal at varying working depths, owing to the reorientation of the scraper wing that would occur during adjustment of the working depth of the row unit if the scraper were mounted to a link whose orientation changes with such adjustment of the working depth.

Accordingly, there remains a need for a winged scraper solution that retains functionality at different working depths of a non-parallel row unit linkage whose scraper-carrying link varies in angular orientation depending on the selected working depth of the row unit.

### SUMMARY OF THE INVENTION

According to one aspect of the invention, there is provided a row unit for a seeding implement, said row unit comprising:
a disc arranged to be displaced across an area of ground in a forward travel direction to open a primary furrow in the ground;
an angularly variable link on which the disc is carried, and whose angular orientation varies with adjustment of a working depth to which the disc penetrates into the ground;
a scraper assembly supported on said angularly variable link and comprising:
   a scraper body supported alongside the disc in a position operable scrape soil buildup therefrom during rotation thereof; and
   a wing projecting laterally from the scraper body to an outer side thereof opposite the disc;
wherein the scraper body is supported in an adjustable manner selectively repositionable into a plurality of differently pitched orientations, relative to said link, about a reference axis that penetrates transversely through a plane of the disc from one side thereof to another in a direction of transverse relationship to the forward travel direction.

According to another aspect of the invention, there is provided a scraper assembly for a row unit of a seeding implement, said scraper assembly comprising:
a mounting bracket attachable to an angularly variable link of the row unit in a mounted position thereon;
a scraper body supported or supportable on said mounting bracket in a mounted state thereon, that when said mounting bracket is attached to the angularly variable link, places the scraper body in a working state situated alongside a disc of the row unit in proximity thereto to scrape soil buildup therefrom during rotation thereof; and
a wing projecting laterally outward from the scraper body to an outer side thereof that faces oppositely of the disc in the working state of the scraper body;
wherein the scraper body is selectively repositionable into a plurality of differently pitched orientations, relative to said mounting bracket, about a reference axis that, in the mounted position of the mounting bracket, penetrates transversely through a plane of the disc from one side thereof to another.

### BRIEF DESCRIPTION OF THE DRAWINGS

One embodiment of the invention will now be described in conjunction with the accompanying drawings in which:

FIG. 1 is a side elevational view of a depth-adjustable row unit of an agricultural seeding implement when set to a relatively shallow furrowing depth, and with a uniquely adjustable scraper assembly of the present invention set at a first selectable orientation suited for that shallow furrowing depth.

FIG. 2 is another side elevational view of the row unit and scraper assembly of FIG. 1, but with the row unit set at a deeper intermediate furrowing depth and the adjustable scraper assembly set at a second selectable orientation suited for that intermediate furrowing depth.

FIG. 3 is yet another side elevational view of the row unit and scraper assembly of FIG. 2, but with the row unit set at an even deeper furrowing depth and the adjustable scraper assembly set at a third selectable orientation for that deeper furrowing depth.

FIG. 4 a front perspective view of the scraper assembly.

FIG. 5 is a side elevational view of the scraper assembly from an outer side thereof.

FIG. 6 is a front elevational view of the scraper assembly.

FIG. 7 is a side elevational view of the scraper assembly from an inner side thereof.

FIG. 8 is a rear elevational view of the scraper assembly.

FIG. 9 is a top plan view of the scraper assembly.

FIG. 10 is a bottom plan view of the scraper assembly.

FIG. 11 is an exploded front perspective view of the scraper assembly.

### DETAILED DESCRIPTION

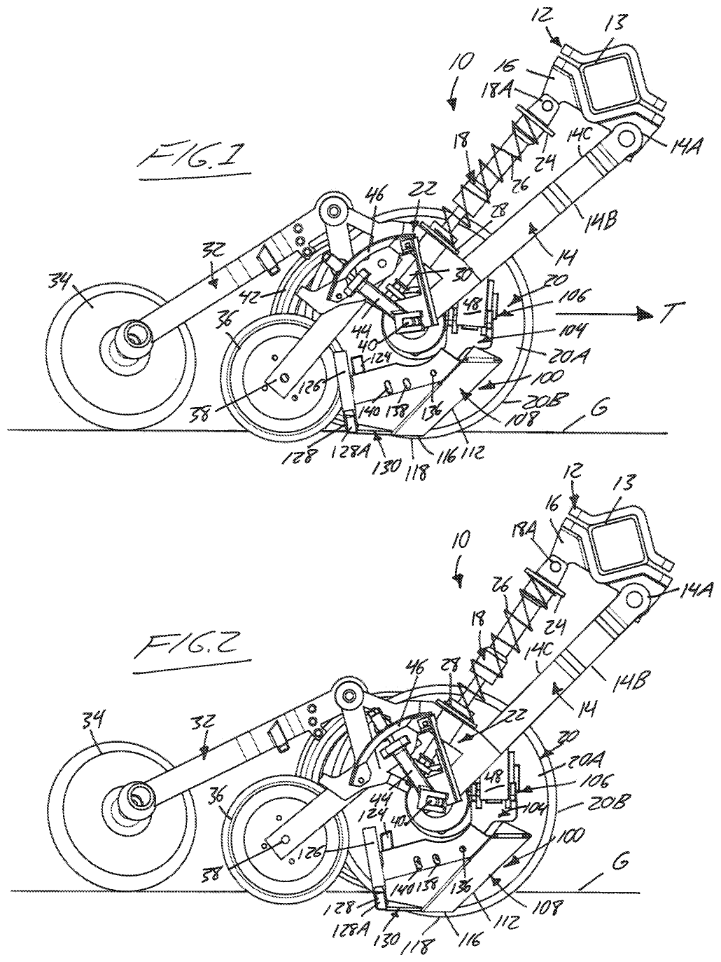

FIGS. 1 through 3 of the appended drawings illustrate a novel scraper assembly of the present invention installed on a row unit 10 of an agricultural seeding implement. The row unit 10 features a linkage composed of a toolbar mount 12 by which the row unit is mounted to a toolbar 13 of the implement, a main arm 14 having an upper leading end 14A pivotably coupled to a bottom bracket 16 of the toolbar mount 12, and a tension link 18 that resides in non-parallel and overhead relation to the main 14 arm, and likewise also has an upper leading end 18A pivotably coupled to the bottom bracket 16 of the toolbar mount 12, but at a higher and more rearward location thereon. The terms leading/forward/front and trailing/rearward/behind are used herein relative to a forward travel direction T in which the toolbar is conveyed over the underlying ground G of an agricultural field over which the implement is towed in order to seed that field. The main arm 14 angles rearwardly downward from the toolbar mount 12, and near a lower trailing end of the main arm 14, carries a coulter disc 20 of the row unit 10 in an upright position and rotatable manner in a disc plane of slightly oblique angle to the forward travel direction T. Owing to this angling of the coulter disc 20 relative to the travel direction T, opposing sides of the coulter disc are referred to as leading and trailing faces thereof, the latter of which is labeled 20A. In operation, the row unit 10 is pulled in the forward travel direction T with its coulter disc 20 at its slightly oblique thereto, and with a lowermost segment of the disc's peripheral edge situated elevationally below the ground surface G, whereby a lower area of the disc creates a furrow trench in the earth by disrupting the soil.

A lower rear portion of the tension link 18 penetrates through a bore in a leading front portion of a divergent arm 22 that is fixed to the main arm 14 and angles upwardly and rearwardly therefrom at a point thereon of proximate, but upwardly and forwardly spaced, relation to both the lower trailing end of the main arm and the rotational axis of the coulter disc 20 rotatably supported near said lower trailing end of the main arm. An upper front portion of the tension link 18 has a fixed spring stop 24 thereon that is abutted by a leading upper end of a coiled compression spring (schematically shown at 26) that encircles the tension link 18. A slidable spring stop 28 on the tension link 18 is abutted by a trailing lower end of the compression spring 26, and is axially displaceable in opposing directions along the tension link 18. The slidable spring stop 28 is carried on a sleeve 30 that encircles the lower portion of the tension link and is slidably disposed in the bore of the divergent arm 22. Upwardly pivoting of the main arm 14 about its pivotably supported leading upper end 14A pushes the divergent arm 22 upwardly and forwardly against the movable spring stop 28, whereby further upwardly pivotal movement of the main arm 14 in this same direction is resisted by the compression spring 26. The spring-loaded tension link 18 is thus operable to resist upward pivoting of the main disc-carrying arm 14.

At an upper rear portion of the divergent arm 22 that trails both the lower trialing end of the main arm 14 and the rotational axis of the coulter disc 20, and that resides in elevated relation to a top rear quadrant of the coulter disc 20, a closing wheel arm 32 is pivotally coupled to the divergent arm 22. The closing wheel arm 32 extends rearwardly from this upper rear portion of the trailing arm 22 at a downwardly angled slope toward the ground G, and, at its lower trailing end, rotatably carries a closing wheel 34. This closing wheel 34 defines a rearmost component of the row unit that trails the remainder thereof, and is operably positioned to close the furrow trench opened by the coulter disc 20. A press wheel 36 is similarly carried in a rotatable manner at a lower trailing end of a press wheel arm 38 whose leading upper end is likewise pivotally coupled to the divergent arm 22 at a position situated rearwardly of the tension link's slidable coupling thereto. The press wheel 36 also resides in trailing relation to the coulter disc 20, but at lesser trailing distance therebehind, and thus resides intermediately of the coulter disc 22 and closing wheel 34 in the forward travel direction T. The press wheel 36 is operably positioned to ride within the furrow, and to press the deposited seed firmly into the dirt for consistent seed placement and uniform emergence.

The main arm 14, divergent arm 22, closing wheel arm 32 and press wheel arm 38 all reside on the trailing side of the coulter disc 20. Carried on the opposing leading side of the coulter disc 20, by way of a crankshaft 40 that extends through a center of the coulter disc 20 from the leading side thereof, is a depth gauge wheel 42 that rides atop the ground G on the leading side of the coulter disc 20. A depth control lever 44 attached to the crankshaft 40 on the trailing side of the coulter disc 20 is operable to pivot the crankshaft 40 about its axis, and thereby adjust a relative elevation between the rotational axis of the depth gauge wheel 42 and that of the coulter disc 20. Such adjustment of relative elevation between the depth gauge wheel 42 and the coulter disc 20 is operable to set the depth to which the coulter disc 20 will penetrate the ground G when the depth gauge wheel rides atop the ground. A depth control bracket 46 is engageable by the depth control lever 44 in a plurality of different positions corresponding to different working depths of the coulter disc 20.

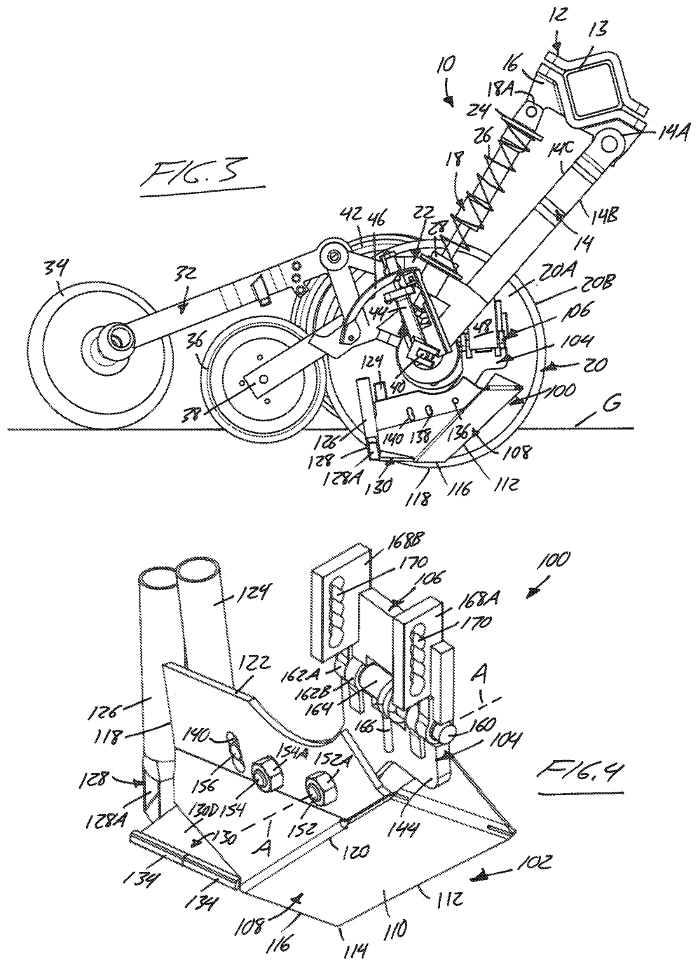

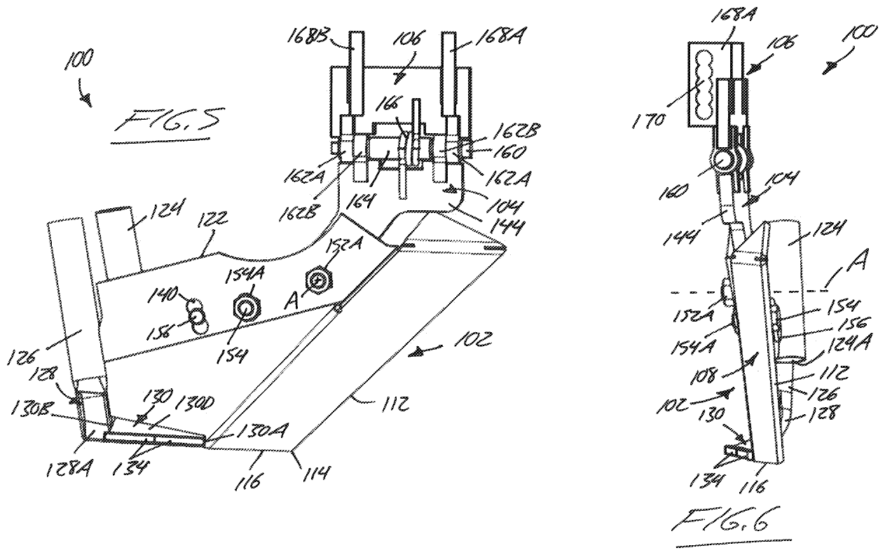

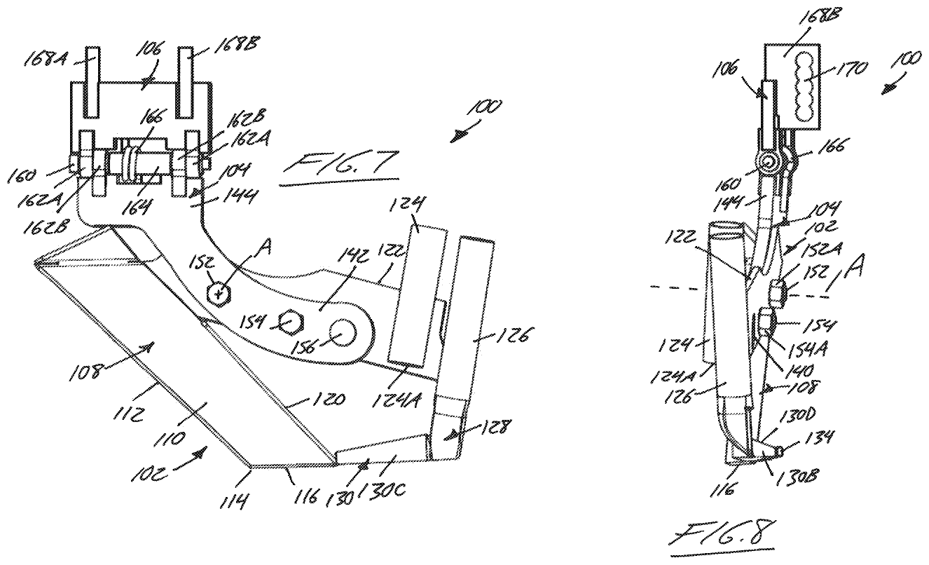

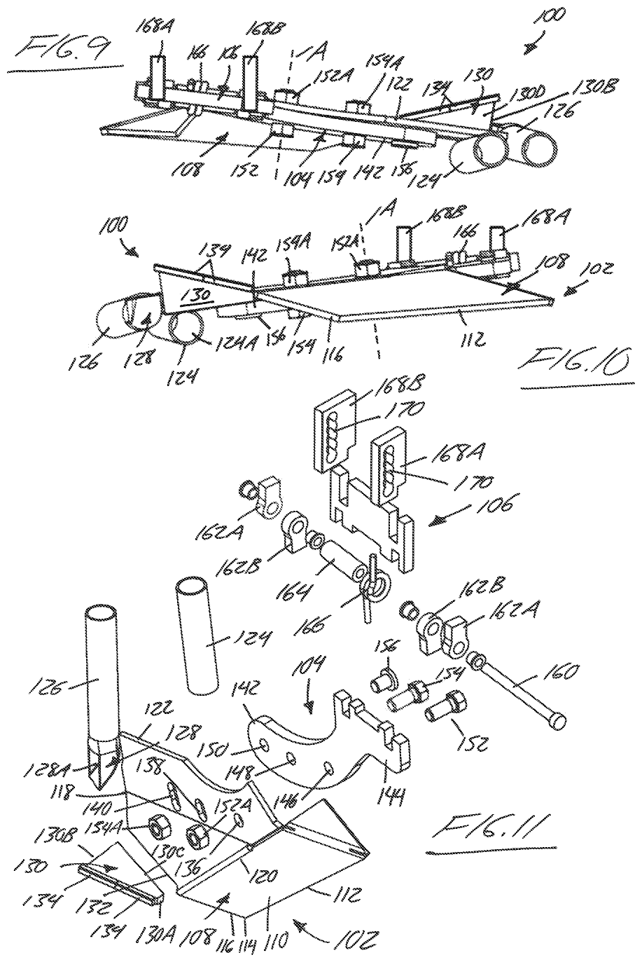

With the coulter disc 20 rotatably supported on the main arm 14, and the depth wheel being settable at different various elevations relative to the coulter disc 20, the angle of the main arm's forward inclination 14 will vary at different working depths of the row unit. This can be seen by comparison of FIGS. 1 through 3, of which FIG. 1 represents a relative shallow working depth creating a relatively shallow furrow trench in the ground, with the main arm 14 at a first angle of forward inclination. FIG. 2 represents an intermediate working depth creating a less shallow furrow trench of greater depth, with the main arm at a steeper second angle of forward inclination. Finally, FIG. 3 represents an even deeper working depth creating a relatively deep furrow trench in the ground, with the main arm at an even steeper third angle of forward inclination.

The main arm 14 features a mounting body 48 fixed thereto and jutting downwardly from an underside 14B thereof at a location thereon situated generally across from where the divergent arm 22 branches off the main 14 at the opposing topside 14C thereof. The mounting body 48 hanging from the main arm 14 resides inside a cylindrical plane denoted by the circular perimeter of the coulter disc 20. Expressed in another way, an entirety of the mounting body 48 is at a lesser radial distance from the coulter disc's rotational axis than the circular perimeter of the coulter disc. The mounting body 48 also resides at a position of leading relation to the central rotational axis of the coulter disc 20. The affixation of the mounting body 48 to the main arm 14 resides in adjacency to a front upper quadrant of the circular area of the coulter disc's trailing face 20A, from which the mounting body reaches downwardly toward, and optionally or sometimes (depending on working depth setting and associated main arm inclination angle) the crosses, a radial plane corresponding to a three o'clock radius of the coulters disc's trailing face 20A.

It is to this mounting body 48 that an OEM seed boot of the row unit would conventionally be mounted, but to which a novel scraper assembly 100 of the present invention is instead mounted in the present context. The mounting body 48 has aligned bolt holes (not shown) in the opposing front and rear sides thereof, through which the OEM seed boot would conventionally be bolted to the mounting body 48, and though which the inventive scraper assembly 100 of the present invention is now instead bolted to the mounting body 48 to thereby secure the scraper assembly 100 to the main arm 14 of the row unit in a position of operable relationship to clean the coulter disc 20 as it rotates during towed forward travel of the seeding implement.

It will be appreciated that the description of the row unit thus far has been of a well-known conventional design that will be familiar to those of ordinary skill in the art, particularly resembling row units used on a number of John Deere seeding implements. Such known row unit componentry has thus been described at a relatively high level to set the context of the present invention, and it will be appreciated that the specific details of various row units on which the inventive scraper assembly may be used may vary. A notable point of novelty of the inventive scraper assembly is an angular adjustability of the winged shelf-forming scraper by which it can achieve a properly effective working orientation among differently inclined angles of the main arm 14 of the row unit at the different working depth settings thereof. As mentioned above in the background, such a problem was not seen in Applicant's prior scraper products designed for use on parallel link row units, where the scraper is instead mounted to a fixed-orientation link whose orientation does not change with adjustment of the row unit's working depth.

The scraper assembly 100 features a scraper 102, a scraper holder 104 to which the scraper 102 is selectively fastenable in a plurality of different angular orientations, and a mounting bracket 106 configured for attachment to the mounting body 48 of the row unit's main arm 14 to mount the scraper assembly 100 thereon. The scraper 102 is composed of a main scraper body 108 defined by one or more metal plates 110, for example a singular plate bent and formed into the described shape, or a set of multiple plates welded together generally edge-to-edge to retain an overall plate-like form, but at relative angles to one another to create the described overall shape. The resulting main scraper body 108 features a leading scraper edge 112 positioned in close proximity to the trailing face 20A of the coulter disc 20 so as to scrape soil from the trailing face 20A of the rotating coulter disc 20 during towed operation of the seeding implement in the forward travel direction T. The scraper edge 112 occupies a front lower quadrant of the disc's trailing face 20A, at an upwardly and forwardly inclined angle spanning from near a six o'clock position of the disc's trailing face toward upwardly and forwardly toward a three o'clock position thereon. A front bottom corner 114 of the scraper body 108 is defined at the lower end of the scraper edge 112 where it meets with a bottom edge 116 of the scraper body 108, which extends rearward from the front bottom corner 114 and obliquely away from the trailing face 20A of the coulter disc 20. The bottom edge 116 extends within a generally horizontal plane situated a short distance above a lowermost six o'clock point 118 of the coulter disc's peripheral edge 20B, which defines a bottommost point of a primary furrow trench formed in the soil by the coulter disc 20.

The scraper body 108 has a bend line 120 at a distance situated rearward from the scraper edge 112, at or near a rearmost end of the bottom edge 116 but forwardly of a trailing rearmost edge 118 of the scraper body. This bend line 120 spans the full height of the scraper body 108 from the bottom edge 116 up to an opposing top edge 122 of the scraper body 108. The bend line 120 denotes a boundary between a front portion of the scraper body that defines the leading scraper edge 112, and a distinctly angled rear portion of the scraper body 108. Rearward of the bend 120, the angle of the rear portion of the scraper body 108 relative to the plane of the coulter disc 20 is lesser than the oblique angle at which the front portion of the scraper resides relative to the plane of the coulter disc. The rear portion thus lies more parallel to the plane of the coulter disc 20 than the front portion, which needs to lie at an oblique angle to create the effective scraping action at the leading edge 112. The term “bend line” is used to denote the overall bent shape of the scraper body that results from this angular deviation between the planes of the front and rear portions, whether this angular deviation is created by an actual bend in a singular piece of metal plate, or by welded attachment of two plates in non-coincident planes to respectively define the front and rear portions of the scraper body.

A first product delivery tube 124 of the scraper assembly 100 depends downwardly between the coulter disc 20 and the scraper body 108 at a position slightly forwardly of the rearmost edge 118 thereof, and spaced notably rearward from the bend line 120, and is affixed to the scraper body 108 in such position. A second product delivery tube 126 resides in close adjacency to the first product delivery tube in a position therebehind and next to the rearmost edge 118 of the scraper body 108, as is likewise affixed to the scraper body 108. A delivery boot 128 is mounted to the bottom end of the second product delivery tube 126, and defines a laterally facing dispensing outlet 128A of the second product delivery tube that faces outwardly away from the trailing face 20B of the coulter disc 20 just behind the rearmost edge 118 of the scraper body 108. In contrast, an open bottom end of the first product delivery tube 124 forms a downwardly facing dispensing outlet 124A thereof.

Accordingly, a first granular product (typically granular fertilizer) dispensed down the first product delivery tube 124 simply drops downwardly from the open bottom end thereof into the bottom of the primary furrow trench cut by the coulter disc 20, while a second granular product (typically seed) dispensed down the second product delivery tube 124 is ejected laterally outward from the delivery boot 128 onto a seed shelf that is cut into the side of the primary furrow trench. The illustrated embodiment is thus configured for double shoot delivery of seed and granular fertilizer. In an alternative embodiment, instead of using the first product delivery tube 124 to place granular fertilizer in the bottom of the primary furrow trench, while simultaneously using the included second product delivery tube 126 to deposit seed onto the side shelf of the furrow, the first product delivery tube 124 may instead be used to place seed in the bottom of the primary furrow trench, and the second product delivery tube 126 may be replaced with a liquid injection line to dispense liquid fertilizer (e.g. anhydrous ammonia, NH₃) into the lateral shelf space of the furrow.

To best cut a notably wide shelf into the side of the primary furrow trench to ensure optimal separation of the double shot seed and fertilizer, the scraper 102 also includes a wing 130 of fixed attachment to the main scraper body 108 in a useful working position spanning laterally outward from the scraper body 108 on an outer side thereof that faces away from the coulter disc 20. In the illustrated example, the wing 130 is composed of a discrete wing member of initially separate character from the main scraper body 108, before being subsequently welded or otherwise attached thereto during manufacture of the scraper 102. As shown, the wing member 130 may be wedge-shaped block of metal stock, or a triangular piece of metal plate, with a linear outer edge spanning from a narrow front tip 130A of the wing member 130 to a wider rear end 130B situated longitudinally opposite the narrow tip. In the illustrated example, the main scraper body 108 has a rearwardly inclined lower rear edge 132 that intersects the bottom edge 116 of the scraper body 108 at a rear end of this bottom edge 116, and angles upwardly and rearwardly therefrom to a bottom end of the upright rearmost edge 118 of the scraper body. An inner edge 130C of the wing 130 is welded to the main scraper body in a position occupying this inclined lower rear edge 132.

Preferably prior to such placement and welding of the wing member during production of the scraper, tungsten carbide or other wear inserts 134 of smaller width than the wing member 130 itself are brazed to the linear outer edge of the wing member to provide improved wear life at what would otherwise be the most exposed and wear-prone area of the wing member 130. Use of the more wear resistant carbide at only this most wear prone outer edge, while metal plate or stock for the remaining bulk of the wing structure, is more cost effective than alternative construction of the entire wing from the more durable carbide material. The topside 130D of the wing 130 has a rearwardly upward incline from the narrow tip 130A of the wing 130 to the wider rear end 1306 thereof, while the carbided outer edge of the wing member 130 resides generally coplanar with the bottom edge 116 of the main scraper body 108 in a generally horizontal plane. The topside of the wing member 130 slopes upwardly from its carbided outer edge toward the main scraper body 108.

The front portion of the scraper body 108 may be placed at a sufficient angle to the coulter disc 20 to cut a shelf into the side of the primary disc-cut furrow trench, whereby the wing 130 projecting further outwardly from the scraper body 108 at the rear portion thereof serves to widen a lower part of the already-cut shelf. Alternatively, the scraper 102 may be oriented relative to the trailing side of the disc so that the entire scraper body 108, except for the attached wing member 130, rides entirely within the shadow of the disc 20, so that the wing member 130 alone cuts a slot-like shelf into the side of the disc-cut primary furrow trench.

It will be appreciated that the “generally horizontal” orientation of the scraper's bottom edge 116 and the wing's carbided outer edge, and the corresponding “generally horizontal” orientation of the resulting shelf in the side of the primary furrow trench, is used to distinguish the more horizontal orientation of these components relative to the vertical depth of the primary furrow trench so that the shelf is a laterally widened area of the furrow, but is not intended to denote that these scraper features and resulting seed shelf must be truly horizontal, or within a certain threshold of such truly horizontal orientation. For example, the shelf may slope downwardly toward its outermost terminus furthest from the primary trench to encourage the shelf-delivered product further toward this end of the shelf to minimize potential falling of the shelf-delivered product into the bottom of the primary furrow trench.

The rear portion of the scraper body 108, at an upper area thereof of closer elevation to a top edge 122 of the scraper body 108 than to the bottom and lower rear edges 116, 132 thereof, features a set of adjustment openings therein by which the scraper can be angularly adjusted about a generally horizontal reference axis that penetrates through the plane of the coulter disc 20 from one side thereof to the other. In the illustrated embodiment, there are three such cooperating adjustment openings in the scraper body 108: a pivot hole 136, a guide slot 138 and a multi-lobed positioning slot 140. Of these three openings, the pivot hole 136 is the forwardmost one of nearest relation to the leading scraper edge 112 and furthest relation to the trailing rearmost edge 118; the multi-lobed positioning slot 140 is the rearmost one of furthest relation from the leading scraper edge 112 and nearest relation to the trailing rearmost edge 118; and the guide slot 138 is the intermediate one of the three, residing between the pivot hole 136 and the multi-lobed position setting slot 140.

The scraper holder 104 is embodied by a metal plate having an elongated rear holding portion 142 for holding the main scraper body 108, and that curves downwardly and rearwardly from a front mounting portion 144 that is attached to the mounting bracket 106. The rear holding portion 142 of the scraper holder 104 has three holes therein, that in sequential order from front to rear include a pivot-stud hole 146, a guide-stud hole 148 and a positioning-stud hole 150, the three of which respectively align with the pivot hole 136, guide slot 138 and positioning slot 140 of the scraper body 108. This rear holding portion 142 with the stud holes 146, 148, 150 resides within the space constrained between the rear portion of the scraper body 108 and the trailing face 20A of the coulter disc 20. A pivot stud 152 penetrates through the pivot-stud hole 146 of the scraper holder 104 from an inner side thereof that faces the coulter disc 20, and projects outwardly from the opposing outer side of the scraper holder 104, and onwardly through the aligned pivot hole 136 in the scraper body. A guide stud 154 likewise penetrates through the guide-stud hole 148 of the scraper holder 104 from the inner side thereof, and projects outwardly from the opposing outer side of the scraper holder 104, and onwardly through the aligned guide slot 138 in the scraper body 108. A positioning stud 156 likewise penetrates through the positioning-stud hole 150 of the scraper holder 104 from the inner side thereof, and projects outwardly from the opposing outer side of the scraper holder 104, and onwardly through the aligned multi-lobed positioning slot 140 in the scraper body 108. The pivot stud 152 and the guide stud 154 both have externally threaded shafts, onto which a pivot-stud nut 152A and guide-stud nut 154A are respectively threaded at the protruding ends thereof at the outer side of the scraper body 108. Tightening of these nuts 152A, 154A on the respective studs 152, 154 is operable to fasten the scraper body 108 securely to the rear holding portion 142 of the scraper holder 104 in any one of a plurality of user-selectable angular orientations thereon. The heads of the three studs 152, 154, 156 are welded to the inner side of the scraper holder 104 so that the studs are fixed thereto as effectively integral components of the scraper holder.

The positioning stud 156 is shorter than the other two studs 152, 154, and doesn't project fully through the multi-lobed positioning slot 140 in the scraper body 108, unlike the pivot and guide studs 152, 154 that project fully through the pivot hole 136 and guide slot 138 to enable fastened connection with the respective nuts 152A, 154A. When the two nuts 152A, 1548 are sufficiently loosened on the threaded shafts of their respective threaded studs 152, 154, the scraper body can be manually pulled away from the scraper holder 104 by a sufficient distance to withdraw the shorter positioning stud 156 from the multi-lobed positioning slot 140, whereupon the scraper body 108 is now manually pivotable about the shaft of the pivot stud 152, which defines the generally horizontal reference axis A that penetrates the plane of the coulter disc 20 in transverse relation to the forward travel direction T, and about which the pitch angle of the scraper body 108 is adjustable.

Pivoting of the scraper body in one direction about this reference axis of the pivot stud 152 pitches the leading scraper edge 112 of the scraper body 108 downwardly relative to the trailing rearmost edge 118, and in doing so, likewise pitches the narrow front tip 130A of the of the wing 130 downwardly relative the wider rear edge 130B of the wing 130. Pivoting of the scraper body in the other direction about the reference axis A of the pivot stud 152 pitches the leading scraper edge 112 of the scraper body 108 upwardly relative to the trailing rearmost edge 118, and in doing so, likewise pitches the narrow front tip 130A of the of the wing 130 upwardly relative the wider rear edge 1308 of the wing 130. The angular range through which the scraper is adjustable in pitch angle about the reference axis A of the pivot stud 152 is limited by the guide stud's constrained engagement within the guide slot 138. The guide slot's elongation is in an upward/downward direction, whereby downward pitching of the scraper body's leading scraper edge 112 is limited by eventual contact of the guide stud with the bottom end of the guide slot 138, and upward pitching of the scraper body's leading scraper edge 112 is limited by eventual contact of the guide stud with the top end of the guide slot 138.

The purpose of the positioning stud 156 and cooperating multi-lobed positioning slot 140 is to positively lock the scraper body's pitch angle about the pivot stud's reference axis in any selected one of a plurality of predefined user-selectable pitch-angles, of which there are three in the illustrated but non-limiting example. The multi-lobed positioning slot 140 of the illustrated embodiment consists of a set of three positioning holes of circular shape, overlapping position and equal diameter to one another. This equal diameter shared by the three positioning holes slightly exceeds that of the positioning stud 156, such that the positioning stud 156 is receivable in any given one of the three overlapping positioning holes of the multi-lobed positioning slot 140. When engaged in any one of the overlapping positioning holes, the positioning stud 156 is constrained in that particular one of the positioning holes, and cannot be shifted into any other adjacent one of these positioning holes. Instead, the scraper body 108 must be pulled off of the positioning stud 56 entirely, when enabled by sufficient loosening or removal of the pivot and guide stud nuts 52A, 54A, and then tilted about the pivot stud's reference axis A to relocate the positioning stud 156 from one of the positioning slot's overlapping positioning holes to another. So once the positioning stud 156 is engaged in a selected one of the overlapping positioning holes of the multi-lobed positioning slot 140 to set the pitch of the scraper body at a desired one of the three selectable pitch angles, subsequent retightening of the pivot and guide stud nuts 52A, 54A locks the scraper body at this selected pitch angle about the pivot stud's reference axis.

While the illustrated example has three overlapping positioning holes forming a three-lobed positioning slot 140, it will be appreciated that the quantity of predetermined user-selectable pitch angles, and corresponding number of positioning holes, may be varied, and depending on the diameters of the positioning stud 156 an corresponding positioning holes, the radial distance of the positioning holes from the pivot hole 136, and the degree of angular spacing between the different user-selectable pitch angles, discretely separate positioning holes of non-overlapping relation may replace the multi-lobed slot 140 composed of overlapping positioning holes.

The front mounting portion 144 of the scraper holder 104 is coupled to the mounting bracket 106 by way of a hinged connection that allows some swinging movement of the scraper holder 104, and the attached scraper body 108, in a roll direction toward and away from the trailing face 20A of the coulter disc 20. To enable this, the hinged connection features a hinge pin 160 engaged through both a first set of knuckles 162A fixed on the mounting bracket 106 at a bottom end thereof, and a second set of knuckles 1628 fixed on the front mounting portion 144 of the scraper holder 104 at a top end thereof. The front mounting portion 144 of the scraper holder 104 resides outside of the confined space between the scraper body 108 and coulter disc 20 at a location residing above the front portion of the scraper body 108 and beneath the mounting body 48 of the row unit's main arm 14. The hinge pin 160 is also engaged through a central sleeve 164 of the hinged connection, which resides between a front subset of the knuckles and rear subset of the knuckles. A torsion spring 166 is disposed around this sleeve 164, and acts between the scraper holder 104 and the mounting bracket 106 to bias the scraper holder 104 and the attached scraper body 108 toward the coulter disc 20, thereby normally maintaining the scraper body's scraper edge 112 in scraping relation to the coulter disc 20.

The mounting bracket 106 has front and rear bolting flanges 168A, 1688 separated by a distance equal to or slightly exceeding the front-to-rear width of the mounting body 48 of the row unit's main arm 14, whereby receipt of the mounting body 48 is accommodated between the bolting flanges 168A, 1688, which have aligned pairs of bolt holes 170 therein. As shown, the bolt holes 170 in each bolting flange 168A, 1688 may optionally be of overlapping relationship to one another to form a multi-lobed bolting slot, similar to the described multi-lobed positioning slot 140 of the scraper body 108. The illustrated and preferable inclusion of multiple bolt holes 170 per bolting flange 168A, 168B enables user selection of which among the aligned bolt hole pairs in the two bolting flanges 168A, 168B to align with the bolt holes in the mounting body 48 of the row unit's main arm 14. Selection from among multiple bolt hole pairs in the bolting flanges 168A, 168B sets a particular height at which the mounting bracket 106 of the scraper assembly is fastened to the mounting body 48 of the row unit's main arm 14. This in turn, sets a height at which the scraper holder 104 and the attached scraper body 108 will reside on the row unit, relative to the bottommost point 118 of the coulter disc 20 thereof. Since the mounting bracket 106 is bolted in a fixed orientation to a non-adjustable mounting body 48 of fixed orientation on the main arm 14 of the row unit, change of the inclination angle of the main arm 14 owing to the depth adjustment of the row unit via the depth control lever 44 would also change the pitch angle of the scraper body 108, if left in a same static position on the scraper holder 104, whereby the wing may no longer be properly oriented to ensure a suitably oriented and cleanly cut shelf in the side of the primary furrow trench. However, the above-described ability to select from different possible pitch angles of the scraper body 108 relative to the scraper holder 104 enables a user to correctively reposition the winged scraper body 108 relative to the main arm 14 of the row unit to correct for the selected depth setting thereof.

To demonstrate this novel functionality, reference is made again to the fully illustrated row unit of FIGS. 1 through 3. In FIG. 2, where the row unit is set at an intermediate working depth (compared to those of FIGS. 1 and 3), the pitch-adjustable scraper body 108 is set at a neutral pitch angle about the transverse reference axis A of the pivot stud 152, with the position stud 156 thus located in a central one of the three overlapping position holes of the multi-lobed position slot 140. In FIG. 1, the row unit is set at a shallower working depth than in FIG. 2, whereby the forward inclination angle of the row unit's main arm 14 is of a reduced gentler slope than in FIG. 2, which if the scraper body 108 were left in the same position on the scraper holder as FIG. 2, would pitch the front ends of the scraper body 108 and attached wing 130 downward. So instead, to compensate for this, the scraper body 108 is adjusted to a positively pitched position on the scraper holder 104, with the position stud 156 located in an uppermost one of the three overlapping position holes of the multi-lobed position slot, to tilt the front ends of the scraper body 108 and wing 130 upward relative to the pitch neutral position of FIG. 2. In FIG. 3, the row unit is set at a deeper working depth than in FIG. 2, whereby the forward inclination angle of the row unit's main 14 is of an increased steeper slope than in FIG. 2, which if the scraper body 108 were left in the same position on the scraper holder as FIG. 2, would pitch the front ends of the scraper body 108 and wing 130 upward. So instead, to compensate for this, the scraper body 108 is adjusted to a negatively pitched position on the scraper holder 104, with the position stud 156 located in a lowermost one of the three overlapping position holes of the multi-lobed position slot 140, to tilt the front ends of the scraper body 108 and wing 130 downward relative to the pitch neutral position of FIG. 2. So, by adjusting the pitch angle position of the scraper body 108 in a local reference frame relative to the scraper holder 104, whose pitch angle is fixed relative to the main arm 14 of the row unit by way of the bolted attachment through bolting flanges 168A, 168B, one can better approximate a targeted ideal working position of the scraper body in a global reference frame of the operating environment of the row unit, in differently angulated positions of the main arm 14 corresponding to different working depth settings of the row unit.

Since various modifications can be made in my invention as herein above described, and many apparently widely different embodiments of same made, it is intended that all matter contained in the accompanying specification shall be interpreted as illustrative only and not in a limiting sense.

1. A row unit for a seeding implement, said row unit comprising:
a disc arranged to be displaced across an area of ground in a forward travel direction to open a primary furrow in the ground;
an angularly variable link on which the disc is carried, and whose angular orientation varies with adjustment of a working depth to which the disc penetrates into the ground;
a scraper assembly supported on said angularly variable link and comprising:
a scraper body supported alongside the disc in a position operable scrape soil buildup therefrom during rotation thereof; and
a wing projecting laterally from the scraper body to an outer side thereof opposite the disc;
wherein the scraper body is supported in an adjustable manner selectively repositionable into a plurality of differently pitched orientations, relative to said link, about a reference axis that penetrates transversely through a plane of the disc from one side thereof to another in a direction of transverse relationship to the forward travel direction.

2. The row unit of claim 1 comprising a pivot stud lying on said reference axis, on which the scraper body is at least partially supported, and about which the scraper body is pivotable during repositioning thereof among said plurality of differently pitched orientations.

3. The row unit of claim 2 wherein the scraper assembly comprises a scraper holder that is suspended from said angularly variable link and through which the scraper is indirectly supported on the angularly variable link, wherein said pivot stud projects from a first one of either said scraper holder or said scraper body into engaged or engageable relation with an aligned pivot hole belonging to a second one of either said mounting bracket or said scraper body.

4. The row unit of claim 2 further comprising a guide stud engaged or engageable in an aligned guide slot in a manner operable to constrain pivotal movement of the scraper body during the repositioning thereof among said plurality of differently pitched orientations.

5. The row unit of claim 3 further comprising a guide stud engaged or engageable in an aligned guide slot in a manner operable to constrain pivotal movement of the scraper body during the repositioning thereof among said plurality of differently pitched orientations, wherein said guide stud projects from the same first one of either said mounting bracket or said scraper body as the pivot stud, and the guide slot belongs to the same second one of either said mounting bracket or said scraper body as the pivot hole.

6. The row unit of claim 4 wherein the guide stud is externally threaded, and is accompanied by a mating guide-stud nut that is threaded or threadable onto the guide stud at a side of the guide slot opposite that from which the guide stud penetrates said guide slot.

7. The row unit of claim 2 wherein the pivot stud is externally threaded, and is accompanied by a mating pivot-nut that is threaded or threadable onto said pivot stud at a side of the pivot hole opposite that from which the pivot stud penetrates said pivot hole.

8. The row unit of claim 1 further comprising a guide stud engaged or engageable in an aligned guide slot in a manner operable to constrain pivotal movement of the scraper body during the repositioning thereof among said plurality of differently pitched orientations.

9. The row unit of claim 8 wherein the guide stud is externally threaded, and is accompanied by a mating guide-stud nut that is threaded or threadable onto the guide stud at a side of the guide slot opposite that from which the guide stud penetrates said guide slot.

10. The row unit of claim 1 further comprising a positioning stud engaged or engageable in any selected one of a plurality a cooperable positioning holes, of which each positioning hole corresponds to a different respective one of the plurality of differently pitched positions of the scraper body, so that, when so engaged, the positioning stud blocks pivotal movement of the scraper body about the reference axis.

11. The row unit of claim 3 further comprising:
a positioning stud engaged or engageable in any selected one of a plurality a cooperable positioning holes, each corresponding to a respective one of the plurality of differently pitched positions, so that, when so engaged, the positioning stud blocks pivotal movement of the scraper body about the reference axis;
wherein said positioning stud projects from the same first one of either said mounting bracket or said scraper body as the pivot stud, and the positioning holes belong to the same second one of either said mounting bracket or said scraper body as the pivot hole.

12. The row unit of claim 10 wherein said positioning holes are of overlapping relation to one another, and thereby form a multi-lobed slot.

13. The row unit of claim 10 wherein said positioning holes reside in the scraper body.

14. A scraper assembly for a row unit of a seeding implement, said scraper assembly comprising:
a mounting bracket attachable to an angularly variable link of the row unit in a mounted position thereon;
a scraper body supported or supportable on said mounting bracket in a mounted state thereon, that when said mounting bracket is attached to the angularly variable link, places the scraper body in a working state situated alongside a disc of the row unit in proximity thereto to scrape soil buildup therefrom during rotation thereof; and
a wing projecting laterally outward from the scraper body to an outer side thereof that faces oppositely of the disc in the working state of the scraper body;
wherein the scraper body is selectively repositionable into a plurality of differently pitched orientations, relative to said mounting bracket, about a reference axis that, in the mounted position of the mounting bracket, penetrates transversely through a plane of the disc from one side thereof to another.

15. The scraper assembly of claim 14 comprising a pivot stud and a pivot hole each belonging to a respective one of either the scraper body or the mounting bracket, and by which the scraper is at least partially supported on the mounting bracket by said pivot stud, and about which the scraper body is pivotable during repositioning thereof among said plurality of differently pitched orientations.

16. The scraper assembly of claim 15 wherein the pivot stud projects from the mounting bracket, and the pivot hole resides in the scraper body.

17. The scraper assembly of claim 16 wherein the pivot stud is externally threaded, and is accompanied by a mating pivot-nut that is threaded or threadable onto said pivot stud at a side of the pivot hole opposite that from which the pivot stud penetrates said pivot hole.

18. The scraper assembly of claim 14 comprising a guide stud and a guide slot each belonging to a respective one of either the scraper body or the mounting bracket, and of which the guide stud is engaged or engageable in the guide slot in a manner operable to constrain pivotal movement of the scraper body during the repositioning thereof among said plurality of differently pitched orientations.

19. The scraper assembly of claim 18 wherein the guide stud projects from the mounting bracket, and the guide slot resides in the scraper body.

20. The scraper assembly of claim 18 wherein the guide stud is externally threaded, and is accompanied by a mating guide-stud nut that is threaded or threadable onto the guide stud at a side of the guide slot opposite that from which the guide stud penetrates said guide slot.

21. The scraper assembly of claim 14 comprising a positioning stud and a cooperable set of positioning holes, of which a first one of either said positioning stud or said cooperable set of positioning holes belongs to a first one of either the mounting bracket or the scraper body, and a second one of either said positioning stud or said cooperable set of positioning holes belongs to a second one of either the mounting bracket or the scraper body, wherein the positioning stud is engageable in any selected one of the cooperable set of positioning holes, of which each positioning hole corresponds to a different respective one of the plurality of differently pitched positions of the scraper body, so that, when so engaged, the positioning stud blocks pivotal movement of the scraper body about the reference axis.

22. The scraper assembly of claim 21 wherein the positioning stud projects form the mounting bracket, and the cooperable set of positioning holes reside in the scraper body.

23. The scraper assembly of claim 22 wherein said positioning holes are of overlapping relation to one another, and thereby form a multi-lobed slot.
